(19) United States
(12) Patent Application Publication
(10) Pub. No.: US 2012/0328789 A1
(43) Pub. Date: Dec. 27, 2012

(54) METAL-GRAPHITE FOAM COMPOSITE AND A COOLING APPARATUS FOR USING THE SAME

(75) Inventors: Minhua Lu, Mohegan Lake, NY (US); Lawrence S. Mok, Brewster, NY (US); Krystyna W. Semkow, Poughquag, NY (US)

(73) Assignee: INTERNATIONAL BUSINESS MACHINES CORPORATION, Armonk, NY (US)

(21) Appl. No.: 13/601,958

(22) Filed: Aug. 31, 2012

Related U.S. Application Data
(62) Division of application No. 11/621,163, filed on Jan. 9, 2007.

(51) Int. Cl. B05D 1/36

(52) U.S. Cl. 427/404

(57) ABSTRACT

A method of producing a metal-graphite foam composite, and particularly, the utilization thereof in connection with a cooling apparatus. Also provided is a cooling apparatus, such as a liquid cooler or alternatively, a heat sink for electronic heat-generating components, which employ the metal-graphite foam composite.

### CROSS REFERENCE TO RELATED APPLICATIONS

The present patent application is a Divisional Application of copending U.S. patent application Ser. No. 11/621,163, filed Jan. 9, 2007 and entitled “Metal-Graphite Foam Composite and A Cooling Apparatus For Using The Same”.

### BACKGROUND

1. Field

The present invention relates to the manufacture of a metal-graphite foam composite, and particularly, the utilization thereof in connection with a cooling apparatus. Moreover, the invention relates to the provision of a cooling apparatus, such as a heat sink for electronic heat-generating components, which employ the metal-graphite foam composite, and to a method of utilization thereof.

In the technology relating to the cooling of electronic components which generate significant amounts of heat during operation thereof, it is frequently an object to provide heat sinking devices and heat spreaders which will remove maximum amounts of heat generated from the heat-generating components, and to then transfer or dissipate this heat to either the exterior or locales where the heat no longer presents a problem. In this connection, although numerous types of heat sinking devices and cooling methods have been developed, it is a necessity that with the ever increasing densities and higher powers employed by these electronic heat-generating components, materials and methods must be developed which will possess the capacity to remove heat more rapidly and more efficiently. In this connection, it is desired that materials be produced which possess a high thermal conductivity and a low thermal expansion coefficient (TEC) so as to render the heat sinking device materials substantially compatible with the thermal expansion coefficients of the heat-generating components, for example, such as semiconductor chips, which are operative elements of electronic devices or installations.

2. Discussion of the Prior Art

Although numerous methods and devices have been developed in the technology concerned with the removal and dissipation of essentially deleterious amounts of heat from heat-generating components of electronic devices or installations, these are still encumbered with some limitations in their operating efficiencies, and also in the methods of production thereof.

Haack, et al., U.S. Pat. No. 6,706,239 B2 discloses a method of co-forming a metal article, which consists of forming a powdered metal component from a first powdered metal composition, providing a polymeric foam and coating the polymeric foam with a second powdered metal composition in order to produce a coated polymeric foam, and thereafter placing the coated polymeric foam into contact with the powdered metal component in order to produce a composite foam structure.

Eesley, et al, U.S. Pat. No. 6,424,529 B2 and Bhatti, et al., U.S. Pat. No. 6,424,531 B1 both relate to high performance heat exchange assemblies, wherein the former patent discloses a heat sink structure consisting of a spreader plate, at least three fins and at least one porous reticulated foam block which fills the space between the fins in order to assist in the absorption and transfer of heat, which is generated by electronic components. Similarly, the second patent, Bhatti, et al., disclose a method of manufacturing the heat sinks using porous foams, and is similar in context to the first mentioned publication, Eesley, et al.

Sugikawa, U.S. Pat. No. 5,655,295 disclose a lead-containing porous metal sheet, and a method for manufacturing the sheet so as to form an essentially heat-conductive and absorbing structure which may be used in the cooling of various heat-generating components.

Valenzuela, U.S. Pat. No. 5,145,001 discloses a method of building a heat exchanger by employing a permeable heat transfer elements. A coolant is passed through the permeable element through passages, which extend normal to an interface between the permeable and porous elements, so as to facilitate the transfer of heat and cooling of electronic or other components which may be contacted therewith.

Rodhammer, et al., U.S. Pat. No. 5,122,422 disclose a method of producing an anode for an X-ray tube from a graphite material, a carbide-forming, high-melting metal component and a multi-layered intermediate layer. In a specific embodiment of the tube, the latter is produced of graphite and a burning track constituted of tungsten or a tungsten-rhenium alloy, which is applied directly to the intermediate layer. This produces a structure which can be employed in the manufacture of a cooling type of material.

Pepper, et al., U.S. Pat. No. 3,918,141 disclose a method of producing a graphite fiber and metal composite materials in order to form a foam which is able to absorb and transfer heat from a hot working station towards a cooler transfer station.

Although the foregoing publications to various extents disclose heat sinks and heat absorbing and conveying materials and structures for utilization thereof, further improvements in the production of foam composite materials and in the cooling of electronic components while employing such materials, are clearly disclosed by the present invention.

### SUMMARY

Accordingly, pursuant to a first aspect of the present invention, a novel composite metal-graphite foam structure is produced by plating graphite foams with copper and then dipping the plated graphite foams into a bath of melting copper in an oven which is filled with an inert gas, such as nitrogen. In the event that a portion of the graphite foam is not intended to be filled with the copper, that part of the copper will not be plated on and dipped into the melting copper bath or will be plated on but not dipped into the melting copper bath. The partially filled graphite foams are quite well-suited for use in conjunction with liquid cooling devices, which are employed for the efficient cooling of heat-generating components, for example, such as semiconductor chip arrangements, in which narrowly spaced fins are called for in obtaining a better heat transfer from a solid surface to the liquid coolant.

The fully copper-filled graphite foams are capable of being adapted to be employed as heat spreaders, which are required to transfer heat from a semiconductor chip to a heat-sinking device.

Pursuant to further aspects of the invention, the structure of the metal-graphite foam composite is adapted to be employed with a liquid cooling device in order to be able to efficiently remove heat from a heat-generating electronic component, such as a semiconductor chip.

Pursuant to another aspect, the novel and inventive metal-graphite foam composite may be utilized in combination with a heat spreader comprising a heat sink which is in contact with a semiconductor chip arrangement through the interposition of a thermal interface.

Accordingly, it is an object of the present invention to provide a novel metal-graphite foam composite, which is adapted as a heat transfer structure and cooling medium for heat-generating components.

Another object of the present invention relates to the provision of an arrangement and to a method of utilizing novel metal-graphite foam composite pursuant to the invention in connection with a liquid cooling device for the removal of heat from semiconductor chips.

Pursuant to another object of the present invention, the metal-graphite foam composite pursuant to the invention is adapted to be utilized in conjunction with a heat spreader configuration employing the composite and an associated heat sink which will facilitate the efficient removal and transfer of heat from a semiconductor chip arrangement.

### BRIEF DESCRIPTION OF THE DRAWINGS

Reference may now be made to the following detailed description of preferred embodiments of the invention, taken in conjunction with the accompanying drawings; in which:

FIG. 1 illustrates generally diagrammatically a perspective view of a metal-graphite foam composite structure pursuant to the invention;

FIG. 2 illustrates a schematic representation of a liquid cooling device utilizing the metal-graphite foam composite pursuant to the invention; and

FIG. 3 illustrates a heat spreader arrangement utilizing the metal-graphite foam composite.

### BRIEF DESCRIPTION OF THE INVENTION

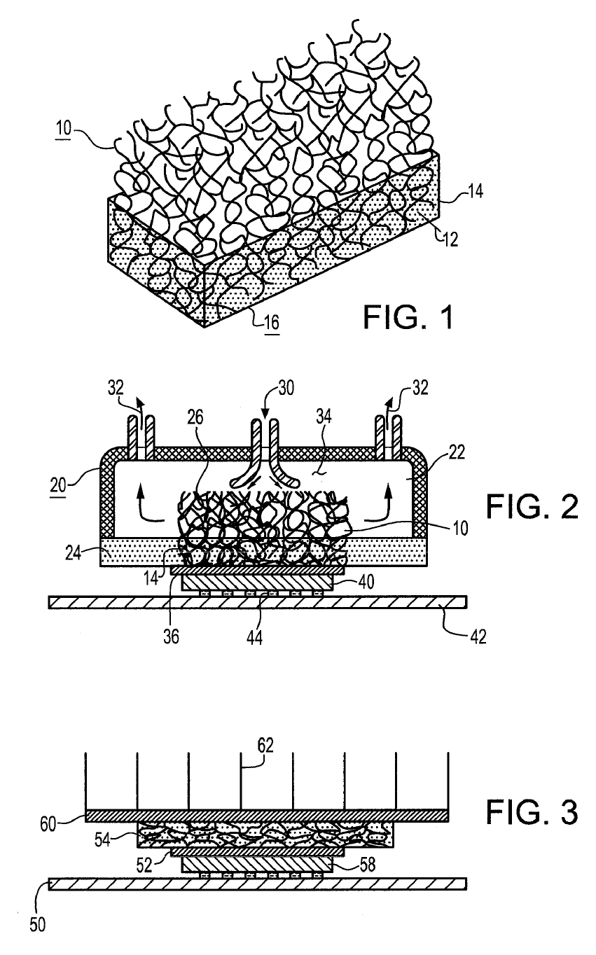

Referring now in specific detail to FIG. 1 of the drawings, there is illustrated a metal-graphite foam composite 10 wherein graphite foam elements 12 are adapted to have the lower portions 14 thereof immersed in a bath 16 consisting of a molten metal, for example, such as copper.

In essence, a significant and important advantage of producing a metal-graphite foam composite 10 resides in that the thermal conductivity of the graphite foam strands or ligaments can be as high as 1700 W/m-k, which is approximately four times (4×) as high as that of copper alone. A graphite foam, which is constituted from a high thermal-conductivity graphite material, has been developed by the Oak Ridge National Laboratory in 1997 and is manufactured and commercialized by Poco Graphite Inc., Decatur Tex. Although, for instance, other material can be conceivably employed, the graphite possesses a ligament conductivity of approximately 1700 W/mK; a bulk thermal conductivity of about 150-245 W/mK; a very high specific surface area which is greater than 20,000 m²/m³; a low coefficient of thermal expansion (CTE) of less than 3 ppm/K; an open porosity which is permeable to fluid; a high thermal diffusivity; a low density light weight; and which can be readily soldered to metallic materials.

As indicated in FIG. 1, in order to form a metal-graphite foam composite 10, wherein metal consists of copper, the graphite foam structure is electroplated with layer of copper, the graphite foam structure has at least a portion thereof dipped into a plating bath; in effect, utilizing a plating procedure in which graphite is rinsed in deionized water for one (1) minute and immersed in a copper sulfate plating bath at room temperature. In addition to stirring the solution with a magnetic stirrer, the graphite foam is agitated or reciprocated perpendicularly or normal to the bath so as to force the plating bath into the foam interstices. The plating current density employed was approximately 30 mA/cm², resulting in a plating rate in the order of 0.5 μm/min. Obtained was a thickness of copper on the graphite foam surfaces in the magnitude of about 3-30 μm. Thus, the structure 10 could be bare graphite foam or graphite foam plated with copper on its surface. An interface integrity between the graphite and copper was analyzed using the SEM of cross-sections. Confirmation was obtained that a fully conformal coating of copper was achieved on the graphite foam at excellent interface integrity between the graphite and copper.

In order to form a partially filled metal-graphite foam structure 10, the lower portion 14 is dipped or immersed into a bath of melting copper in an oven which is filled with an inert gas; for example, such as nitrogen. The part of the plated graphite foam, which is not intended to have its interstices filled with copper, is not dipped into the melting copper bath. Resultingly, the lower portion of the metal-graphite foam composite consists of graphite foams with interstices filled fully with copper 12. The resulting piece, upon cooling thereof has a solid lower part and an upper porous part. The upper foam composite part can be either plated with copper or comprise bare graphite foams which will have advantageous in use in liquid cooling devices. On the other hand, the fully filled foam part, such as the lower solid portion of the structure may be employed as a heat spreader which transfers heat from a semiconductor chip to a heat sinking device, as described hereinbelow.

The foregoing metal-graphite foam composite 10 is adapted to be readily installed in a liquid cooling device 20, as illustrated generally diagrammatically in FIG. 2 of the drawings. In that instance, there is disclosed a liquid cooling device 20 in the form of a chamber 22, wherein the bottom wall 24 of the chamber includes a portion which comprises a metal-graphite foam composite 10, which has been produced in accordance with the method employed as elucidated in connection with FIG. 1, and with graphite foam fins 26 which may or may not necessarily be plated with metal, such as copper, extending upwardly into the confines of the chamber 22. The chamber 22 includes a cover portion 28 extending in spaced relationship over the graphite foam fins 26, and which includes a central liquid inlet 30, and outlets 32 facilitating the circulation of a coolant 34.

The bottom wall 24 of the liquid cooling chamber 22, which comprises the metal-graphite foam composite 10, has a thermal interface 36 in the form of a plate located therebeneath, which is contacted by a semiconductor chip 40, mounted on a substrate 42 through the interposition of suitable solder balls 44 or connections, as is well-known in the technology.

In operation, the coolant enters into the chamber 22 through inlet 30 and strikes the exposed surface portions of the graphite foam fins 26 above bottom wall 24, and thereafter flows through the pores or interstices of the graphite foam. As the coolant passes through the graphite foam interstices, it absorbs heat from the graphite foam, which has been transmitted to the latter through the metal-graphite foam composite 10 by the heat which was generated by the semiconductor chip 40 and then through the thermal interface 36 to the solid base portion 14 of the metal-graphite foam composite 10 in the liquid cooling device 20, and is conducted upwardly to the outlets 32 of the cooling device chamber 22. The foregoing provides for an extremely efficient structure and method for continually cooling the semiconductor chip 40 during the operation thereof.

Reverting to the embodiment of FIG. 3 of the drawings, a semiconductor chip arrangement 50 has a thermal interface 52 in the form of a plate contacting a metal-graphite foam composite 54, which, in this instance, is in the form of a block element wherein the graphite foam interstices are totally filled with a metal, such as copper, and which is positioned in surface contact on the thermal interface plate 52. Inasmuch as the graphite foam constituent of the block element 54 has a lower thermal expansion coefficient (TEC) than that of copper, the TEC of this composite is somewhat lower than that of copper and a low TEC heat spreader imparts a lower mechanical stress to the semiconductor chip 58 in the employment of a solder-connect thermal interface element. The heat which is transmitted to the metal-graphite foam composite member 54 through the thermal interface 52 from the semiconductor chip 58 of the arrangement 50, is then transmitted to a heat sink comprising a plate-shaped heat spreader 60 having a plurality of heat sink fins 62 extending upwardly therefrom, and which is located on the opposite side of the metal-graphite foam composite structure. This will provide for an efficient transfer of heat from the semiconductor chip 58 to the heat sink, while generating extremely low stress acting on the semiconductor chip.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but to fall within the spirit and scope of the appended claims.

What is claimed is:

1. A method of producing a metal-graphite foam composite structure for the cooling of heat-generating devices; said method comprising:
providing a matrix of graphite foam;
plating said graphite foam matrix with a metal so as to form a metal-graphite foam composite; and
immersing at least a lower portion of said metal-graphite foam matrix into a bath of molten metal so as to fill the interstices of said metal-graphite foam matrix in said lower portion thereof with said metal.

2. A method as claimed in claim 1, wherein said graphite foam is plated with copper to form said metal-graphite foam matrix.

3. A method as claimed in claim 2, wherein a portion of said graphite foam is bare and the rest of the graphite foam is plated with copper.

4. A method as claimed in claim 1, wherein the metal to be plated on the graphite foam are metals other than copper, which are compatible with graphite and having a high thermal conductivity.

5. A method as claimed in claim 1, wherein said molten metal bath is constituted of copper filling the foam interstices so as to produce a solid structure in at least said lower matrix portion.

6. A method as claimed in claim 1, wherein said molten metal bath is implemented in an oven filled with an inert gas atmosphere.

7. A method as claimed in claim 6, wherein said inert gas atmosphere comprises nitrogen gas.
